(19) United States
(12) Patent Application Publication
(10) Pub. No.: US 2026/0023463 A1
(43) Pub. Date: Jan. 22, 2026

(54) METHOD, DEVICE, AND MEDIUM FOR COLLECTION SHARING

(71) Applicant: Bytedance Technology Ltd., Grand Cayman (KY)

(72) Inventors: Heng HUANG, Beijing (CN); Youngiek SONG, Singapore (SG); Zexi LIU, Los Angeles, CA (US); Minxuan ZHANG, Beijing (CN); Yangqiao WU, Beijing (CN); Zhiyuan LIU, Beijing (CN); Qin ZHAO, Beijing (CN); Weidong YAO, Beijing (CN); Chen LI, Beijing (CN); Yingying ZHANG, Beijing (CN)

(21) Appl. No.: 19/340,797

(22) Filed: Sep. 25, 2025

(51) Int. Cl. G06F 3/0484

(52) U.S. Cl. CPC G06F 3/0484

(57) ABSTRACT

Embodiments of the present disclosure provide an interaction method, device, and medium for creating or sharing a collection. The method comprises displaying an interactive control for creating a collection. And the method comprises in response to detecting a user operation on the interactive control for creating a collection, creating the collection for the user. And the method further comprises displaying at least one object with an interactive control for adding the object to the collection. In addition, the method further comprises in response to detecting a user operation on the interactive control for adding the object to the collection, adding a link of the object into the collection, wherein the collection comprises a plurality of links of a plurality of objects.

### BACKGROUND

Currently, users of social or e-commerce websites or applications can select a product through the corresponding social or e-commerce websites or applications, share one product link with fan users on and off the website, and earn commissions when fan users click on the links or/and place orders.

### SUMMARY

In a first aspect according to some embodiments of the present disclosure, an interaction method for creating a collection is provided. The method comprises displaying an interactive control for creating a collection. And the method comprises in response to detecting a user operation on the interactive control for creating a collection, creating the collection for the user. And the method further comprises displaying at least one object with an interactive control for adding the object to the collection. And the method further comprises in response to detecting a user operation on the interactive control for adding the object to the collection, adding a link of the object into the collection, wherein the collection comprises a plurality of links of a plurality of objects.

In a second aspect according to some embodiments of the present disclosure, an electronic device comprising a memory and a processor is provided. The memory is configured to store computer instructions which, when executed by the processor, cause the processor to display an interactive control for creating a collection. The instructions further cause the processor to in response to detecting a user operation on the interactive control for creating a collection, create the collection for the user. In addition, the instructions further cause the processor to display at least one object with an interactive control for adding the object to the collection. And the instructions further cause the processor to in response to detecting a user operation on the interactive control for adding the object to the collection, add a link of the object into the collection, wherein the collection comprises a plurality of links of a plurality of objects.

In a third aspect according to some embodiments of the present disclosure, a non-transitory computer-readable medium is provided. The medium comprises instructions stored thereon which, when executed by a processor, cause the processor to display an interactive control for creating a collection. The instructions further cause the processor to in response to detecting a user operation on the interactive control for creating a collection, create the collection for the user. In addition, the instructions further cause the processor to display at least one object with an interactive control for adding the object to the collection. And the instructions further cause the processor to in response to detecting a user operation on the interactive control for adding the object to the collection, add a link of the object into the collection, wherein the collection comprises a plurality of links of a plurality of objects.

Any of the one or more above aspects in combination with any other of the one or more aspects. Any of the one or more aspects as described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 shows an application scenario in which one or more embodiments of the present disclosure may be implemented;

FIG. 2 is a flow chart illustrating an example interaction process for creating a collection with a plurality of product links according to some embodiments of the present disclosure;

FIGS. 3A to 3F illustrate schematic diagrams of an interaction example for creating a collection through a collection interaction interface according to some embodiments of the present disclosure;

FIGS. 4A to 4E illustrate schematic diagrams of an interaction example for sharing a collection within the platform through a collection interaction interface according to some embodiments of the present disclosure;

FIGS. 5A to 5G illustrate schematic diagrams of an interaction example for sharing a collection across different platforms through a collection interaction interface according to some embodiments of the present disclosure;

FIG. 6 shows a schematic diagram of the collaborative work of different data centers used in the present disclosure for creating or sharing collections according to some embodiments of the present disclosure;

FIG. 7 shows a schematic diagram of the sharing workflow process according to some embodiments of the present disclosure;

FIG. 8 shows a schematic diagram of the sharing workflow process for sharing product collection through in-application direct message channels according to some embodiments of the present disclosure;

FIG. 9 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents. A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are an open-ended inclusion, namely, “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description. Concepts such as “first” and “second” mentioned in the present disclosure are only for distinguishing different apparatuses, modules, or units, and are not intended to limit the order or relation of interdependence of functions performed by these apparatuses, modules, or units. Variants of “one” and “a plurality of” mentioned in the present disclosure are illustrative and not restrictive, and those skilled in the art should understand that unless otherwise explicitly specified in the context, the modifiers should be understood as “one or more”. The names of messages or information exchanged between apparatuses in the implementations of the present disclosure are provided for illustrative purposes only, and are not used to limit the scope of these messages or information. Data (including the data itself, and data acquisition, or usage) involved in the technical solutions should comply with the requirements of corresponding laws and regulations, and relevant stipulations.

As mentioned above, the users of social or e-commerce websites or applications can select a product through the corresponding social or e-commerce websites or applications, share one product link with fan users on and off the website. However, due to the low efficiency and weak relevance of individual items, users are seeking to improve efficiency and group items by theme, such as sharing summer outfit lists or Christmas goodies. Currently, existing methods cannot group items once and reuse them in multiple scenarios, requiring a fresh list to be created each time a list is sent. Some existing methods also prevent previewing the list after sending it, resulting in low conversion efficiency.

Furthermore, some existing methods can create lists when sharing externally, but they cannot share the entire list link. Each item is generated as a separate link, preventing users from viewing the aggregated page and reducing browsing efficiency. Previews are also not available externally, requiring users to enter the relevant application to view them. Therefore, there is a need for a tool that allows users to organize or share items conveniently, hereinafter referred to as “collection”.

Therefore, it can be seen that a method or system is needed to solve at least one of the above multiple problems. The present disclosure proposes an interaction method, device, system, medium, etc. for creating a collection or sharing the collection. Exemplarily, the embodiments of the present disclosure provide a collection interface to create or share the collection with a plurality of product links. Furthermore, the embodiments of the present disclosure further provide server-side backend support for the collection interface to create or share the collection with a plurality of product links.

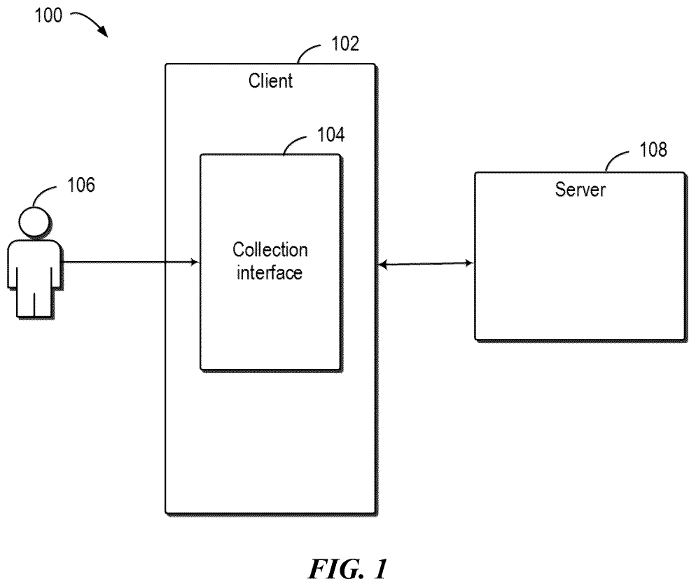

FIG. 1 shows an application scenario 100 in which one or more embodiments of the present disclosure may be implemented. Referring to FIG. 1, the scenario 100 may include a client 102 and a server 108. In some embodiments, the client 102 may interact with the server 108 for creating or sharing a collection with a plurality of product links etc. The client 102 may be a personal computer, a smart phone, a laptop etc., or the client 102 may be another server. It is worth noting that one or more embodiments of the present disclosure do not impose any restrictions on the type of the client 102. Any client suitable for the present disclosure should be within the scope of protection of the present disclosure. In some embodiments, the server 108 may act as a Partner Center. In some embodiments, the server 108 may be located in a cloud. In some embodiments, the server 108 may exchange information with the client 102 for creating or sharing a collection with a plurality of product links etc. On the other hand, the client 102 may include a collection interface 104, and a user 106 may interact with the collection interface 104 to draft, share or review the collection etc.

Next, multiple embodiments of the present disclosure will be described in detail with reference to the relevant drawings and based on the scenario 100 according to one or more embodiments of the present disclosure.

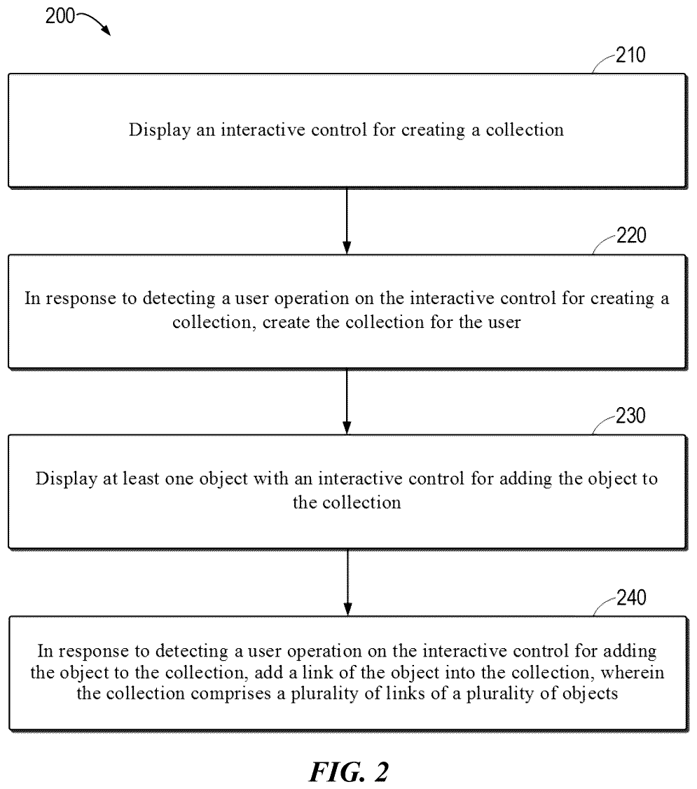

FIG. 2 is a flow chart illustrating an example interaction process 200 for creating a collection with a plurality of product links according to some embodiments of the present disclosure. The example interaction process 200 may be implemented by a computing device, and may be implemented in the scenario 100. The present disclosure does not specifically limit the specific implement of the process 200. Any suitable implement of process 200 for the present disclosure should be within the protection scope of the present disclosure. As shown in FIG. 2, at block 210, an interactive control is displayed for creating a collection. In some embodiments, the client 102 may display the interactive control for creating a collection through the collection interface 104. In some embodiments, the server 108 may send the codes of the collection interface 104 to the client 102 which, when executed on the client 102, may display the collection interface 104 on the client. In some embodiments, the codes may be JAVA code etc.

At block 220, in response to detecting a user operation on the interactive control for creating a collection, the collection may be created for the user. In some embodiment, the user 106 may click the interactive control for creating a collection in the collection interface 104, and the client 102 may detect the user clicking operation on the interactive control for creating a collection. Then, the client 102 may create an initial collection for the user 106. In some embodiment, the initial collection may have a name or a description. In some embodiment, the process 200 may comprise displaying an input field for naming the collection, and in response to detecting a user input in the input field for naming the collection, receiving a user input for naming the collection, and generating, based on the user input for naming the collection, a name for the collection. In some embodiment, the process 200 may further comprise displaying an input field for describing the collection, and in response to detecting a user input in the input field for describing the collection, receiving the user input for describing the collection, and generating, based on the user input for describing the collection, a description for the collection.

At block 230, at least one object is displayed with an interactive control for adding the object to the collection. In some embodiments, the at least one object or an object list of a plurality of objects may be displayed in the collection interface 104 for the user 106 to select. In some embodiments, the at least one object or the object list of a plurality of objects may be recommended by the server 108. In some embodiments, the at least one object or the object list of a plurality of objects may be searched by the user per se. In some embodiments, the process 200 may comprise receiving a user search request for the object, and searching data of the object, and displaying the data of the object. In some embodiments, each object is displayed with the interactive control for adding the object to the collection. Once the user 106 click the interactive control in the collection interface 104, the object may be added to the collection.

At block 240, in response to detecting a user operation on the interactive control for adding the object to the collection, a link of the object is added into the collection, wherein the collection comprises a plurality of links of a plurality of objects. In some embodiments, once the user 106 click the interactive control in the collection interface 104, the client 102 may detect the user click operation, and the client 102 may add the link of the object into the collection, which means the collection has included the object. In some embodiments, the user 106 may select a plurality of objects to add them into the collection, which means the collection comprises a plurality of links of a plurality of objects.

In some embodiments, the process 200 may further comprise displaying an interactive control for sharing the collection, and in response to detecting a user operation on the interactive control for sharing the collection, sending the collection to a target user device specified by the user. In some embodiments, the target user device is linked to a different platform from a platform linked by the user device. In some embodiments, in response to detecting the user operation on the interactive control for sharing the collection, a chain key is generated for a session for sharing the collection, and a schema is generated for sharing the collection based on data of the collection and the chain key.

In some embodiments, a short Uniform Resource Locator (URL) representing the schema is generated based on the schema for sharing the collection. In some embodiments, sending the collection to the target user device specified by the user device may comprise sending the short URL of the collection to a target user device specified by the user device. In some embodiments, in response to receiving a request to access the collection from the target user device and the target user device being linked to a platform linked by the user device, a specific page of the collection is sent to the target user device. In some embodiments, the request to access the collection from the target user device is sent via clicking the shared short URL by the target user. In some embodiments, the specific page of the collection is opened by the target user based on the schema. In some embodiments, a sales activity of the target user is tracked based on the chain key.

In some embodiments, the process 200 may further comprise displaying a plurality of platforms for the user to select to share the collection. In some embodiments, the process 200 may further comprise in response to detecting a user selection of a platform of the plurality of platforms, and sending the collection to the selected platform linked by a target user device specified by the user. In some embodiments, the process 200 may further comprise displaying an interactive control for renewing the collection, and in response to detecting a user operation on the interactive control for renewing the collection, updating data of the collection, and displaying the updated collection for the user. In some embodiments, the updated collection is re-rendered based on the updated data of the collection. In some embodiments, the collection may be shared by the target user to a second target user among the plurality of platforms.

In this way, the process 200 provides the method and the collection interface to create or share the collection with a plurality of product links. And the process 200 creates the collection, which can be easily accessed and called in various application scenarios. When sharing outside the platform site, the collection preview can be displayed outside the client, including the collection description and product list. The user clicks and then jumps to the relevant application. When sharing within the platform site, the user can access the list in the shortcut area with one click and send it with one click. The process 200 can provide users with a convenient collection creation and sharing process. After the collection is created, the latest product list will be pulled and displayed to the end user each time it is shared. On the sharing side, the process 200 can directly preview the product list outside the platform site, which improves the conversion efficiency of potential users.

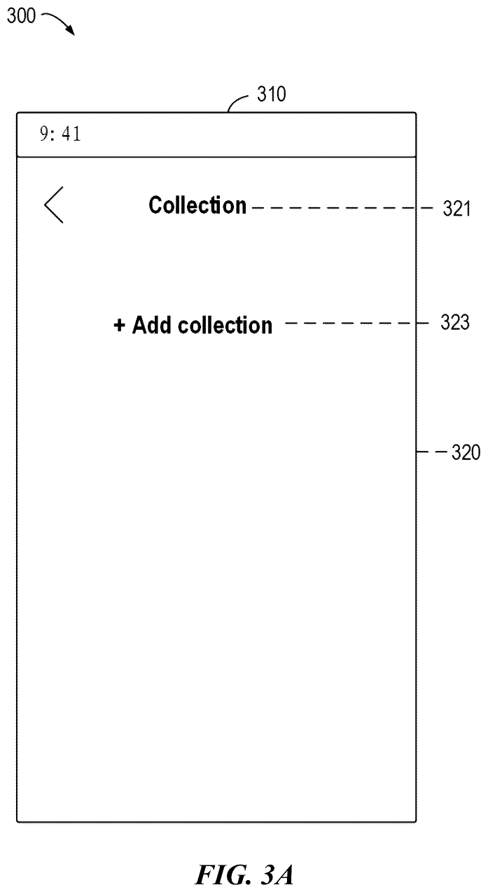

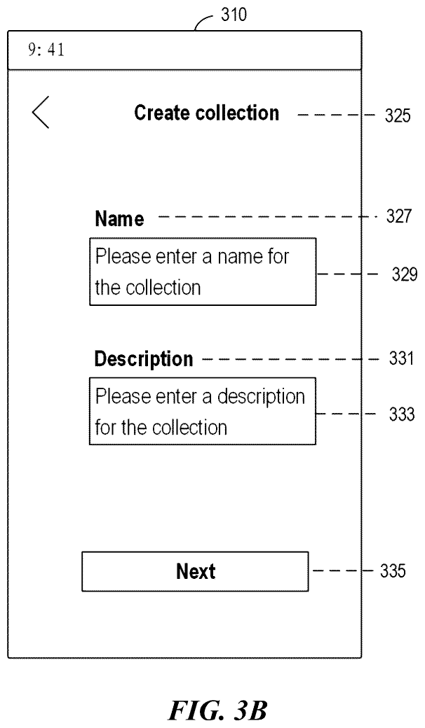

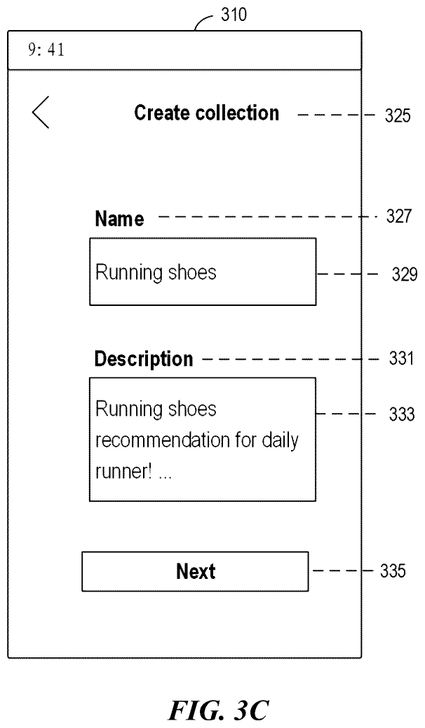

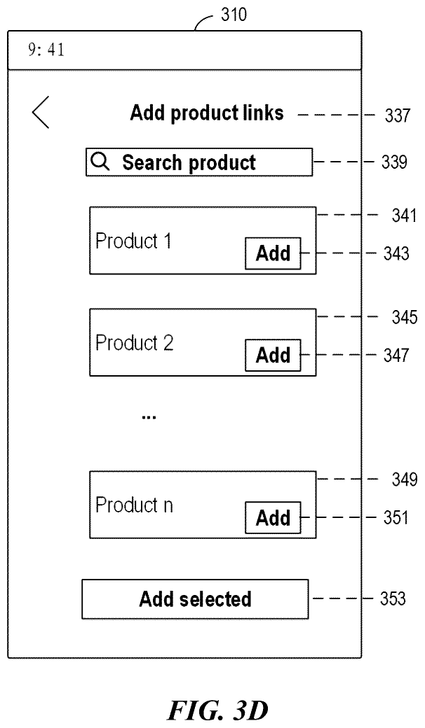

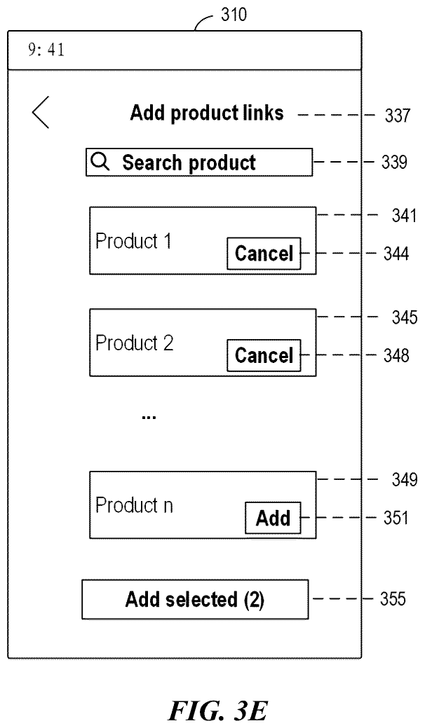

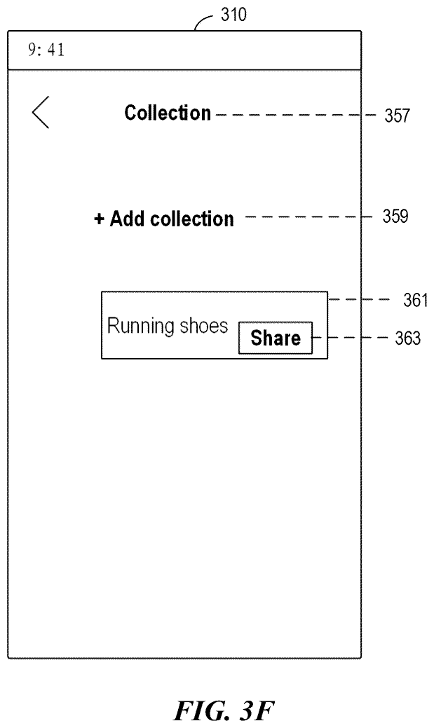

To help those skilled in the art further understand the present disclosure, FIGS. 3A to 3F illustrate schematic diagrams of an interaction example 300 for creating a collection through a collection interaction interface according to some embodiments of the present disclosure. FIG. 3A illustrates an example of an initial state according to some embodiments of the present disclosure. FIG. 3B illustrates an example of inputting a collection name and description according to some embodiments of the present disclosure. FIG. 3C illustrates an example of generating a collection name and description according to some embodiments of the present disclosure. FIG. 3D illustrates an example of adding a product link to a collection according to some embodiments of the present disclosure. FIG. 3E illustrates an example of completing the addition of a product link according to some embodiments of the present disclosure. FIG. 3F illustrates an example of generating a new collection according to some embodiments of the present disclosure. It is worth noting that the collection interaction interface illustrated in the interaction example 300 for generating a collection through a collection interaction interface is merely exemplary. Those skilled in the art may employ any suitable interaction interface based on the basic concepts of the present disclosure to implement one or more embodiments of the present disclosure. Any suitable interaction interface based on the basic concepts of the present disclosure shall fall within the scope of protection of the present disclosure.

As shown in FIG. 3A, the interaction example 300 includes the collection interaction interface 320 displayed in the client 310. The collection interaction interface 320 includes the read-only text input box 321 and the operative control 323 for the user to add a new collection. In the collection interaction interface 320, the user may click the operative control 323 to add a new collection. Once detecting the clicking operation of the user on the operative control 323, the interaction example 300 may display the collection interface shown in FIG. 3B.

Referring now to FIG. 3B, the interaction example 300 may include the read-only text input box 325 for creating collection, the read-only text input box 327 for naming the collection, the text input box 329 for the user to input the name for the collection, the read-only text input box 331 for describing the collection, the text input box 333 for the user to input the description for the collection, and the operative control 335 for a next step for the collection creating. In FIG. 3B, the user may input a name for the collection at the text input box 329, and the user can also input a description for the collection at the text input box 333. FIG. 3C shows the user has input the name of “Running shoes” for the collection at the text input box 329, and the user has input the description of “Running shoes recommendation for daily runner! . . . ” at the text input box 333. Once detecting the clicking operation of the user on the operative control 335 in FIG. 3C, the interaction example 300 may display the collection interface shown in FIG. 3D.

As shown in FIG. 3D, the interaction example 300 may include the read-only text input box 337 for adding product links, the searching box 339 for searching candidate products for the user to select, the read-only text input boxes 341, 345 and 349 etc. with interactive controls 343, 347 and 351 etc. for the user to add products for the collection, and the operative control 335 for adding selected products for the collection. In FIG. 3D, the user can search products in the searching box 327. And the search result may show as the read-only text input boxes 341, 345 and 349 etc. with interactive controls 343, 347 and 351 etc. for the user to add products for the collection. The user can also click the interactive controls 343, 347 and 351 etc. to select the products. Once detecting the clicking operation of the user on the interactive controls 343, 347 and 351 etc. to add selected products in FIG. 3D, the interaction example 300 may display the collection interface shown in FIG. 3E.

Referring now to FIG. 3E, the interaction example 300 may include the read-only text input box 337 for adding product links, the searching box 339 for searching candidate products for the user to select, the read-only text input boxes 341, 345 and 349 etc. with interactive controls 344, 348 and 351 etc. for the user to delete or add products for the collection, and the operative control 353 for adding selected products for the collection. In FIG. 3E, because the user has clicked the interactive controls 343 and 347 in FIG. 3D, the statuses of the interactive controls 343 and 347 in FIG. 3D have been changed to the statuses of the interactive controls 344 and 348 in FIG. 3E, e.g., from “Add” to “Cancel”, which means the user can delete the added products from the collection by clicking the interactive controls 344, 348. The status of the operative control 335 shows two products have been selected by the user to add to the collection as “Add selected (2)”. Once detecting the clicking operation of the user on the operative control 355 in FIG. 3E, the interaction example 300 may display the collection interface shown in FIG. 3F.

As shown in FIG. 3F, the interaction example 300 may include the read-only text input box 357 for creating collection, the interactive control 359 for creating a new collection, and the current created collection 361 for sharing or further editing. The current created collection 361 may include the sharing control 363. And the user can click the sharing control 363 to share the current created collection 361 within or outside of the platform connected by the client 310. In some embodiments, the sharing control 363 may be omitted, and the user can share the collect by only clicking the current created collection 361. In this way, the interaction example 300 enables users to quickly and conveniently create collections, and it is very convenient for users to share between different applications and platforms, greatly improving the user experience.

When sharing within the platform, existing technology doesn't allow for direct sending of lists within chat shortcuts. Instead, users have to select a list from a current list and then send it to the corresponding conversation, forcing the user to exit the conversation and causing a poor user experience. Furthermore, it's not possible to select a previously created list to send, resulting in low efficiency. Furthermore, when sharing externally, lists cannot be previewed outside the site and must be viewed in the same app, reducing conversion efficiency. The following embodiments of the present disclosure will address one or more of these issues.

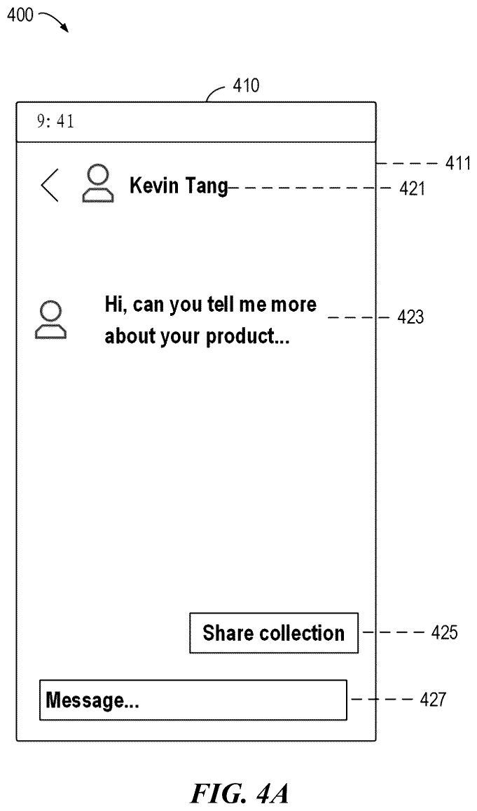

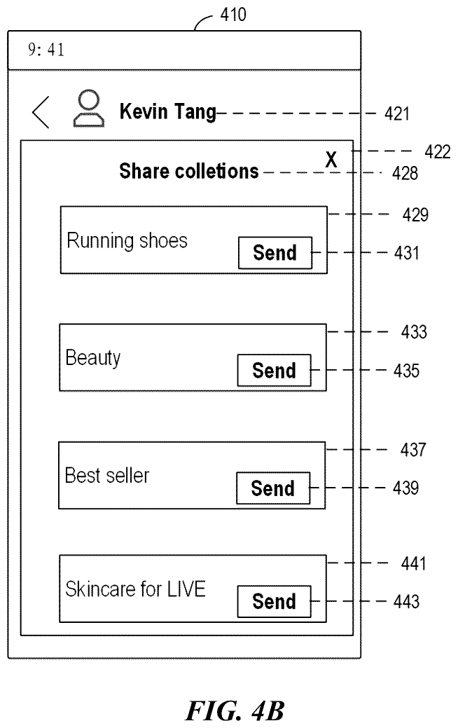

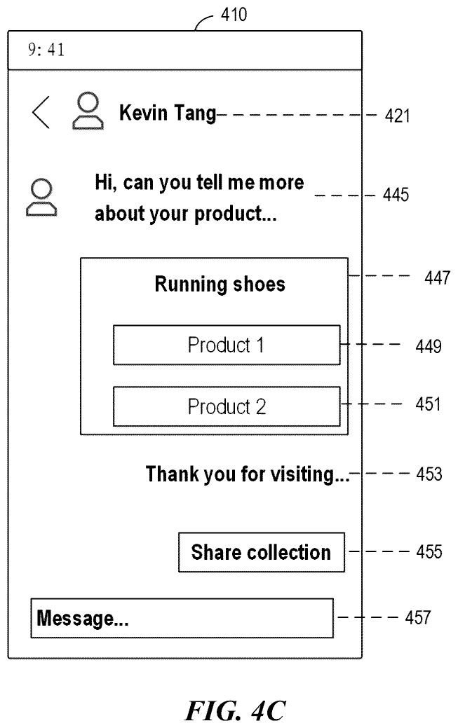

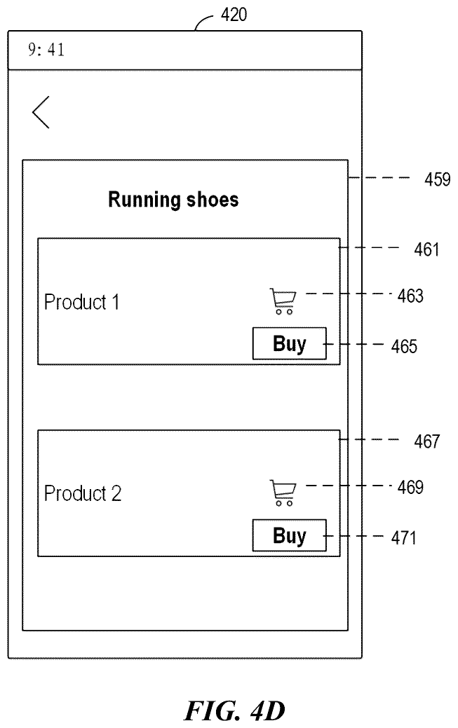

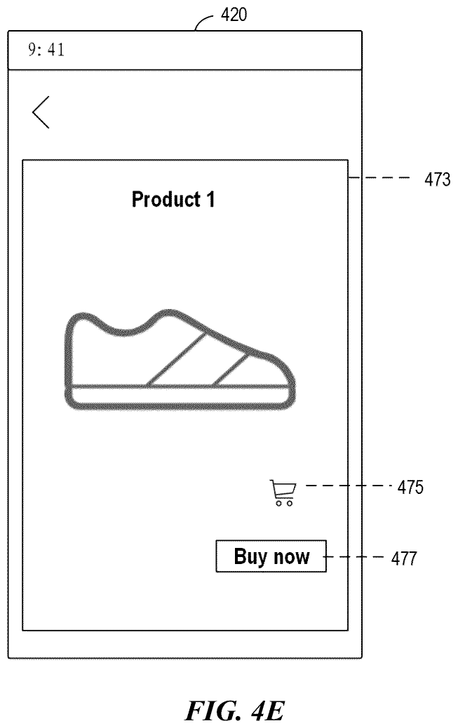

To help those skilled in the art further understand the present disclosure, FIGS. 4A to 4E illustrate schematic diagrams of an interaction example 400 for sharing a collection within the platform through a collection interaction interface according to some embodiments of the present disclosure. FIG. 4A illustrates an example of an initial state according to some embodiments of the present disclosure. FIG. 4B illustrates an example of sharing a collection according to some embodiments of the present disclosure by the user. FIG. 4C illustrates an example of sending a collection to the target user according to some embodiments of the present disclosure. FIG. 4D illustrates an example of accessing a collection according to some embodiments of the present disclosure by the target user. FIG. 4E illustrates an example of accessing a product of a collection according to some embodiments of the present disclosure by the target user. Those skilled in the art may employ any suitable interaction interface based on the basic concepts of the present disclosure to implement one or more embodiments of the present disclosure. Any suitable interaction interface based on the basic concepts of the present disclosure shall fall within the scope of protection of the present disclosure.

As shown in FIG. 4A, the interaction example 400 includes the dialog interface 411 displayed in the client 410. The dialog interface 411 includes the read-only text input box 421 for showing the target user name, the read-only text input box 423 for displaying the message from the target user, the operative control 425 for the user to share a collection, and the editable text input box 427 for the user to input a message for the target user. In the dialog interface 411, the user may click the operative control 425 to share a collection in the dialog interface 411. Once detecting the clicking operation of the user on the operative control 425, the interaction example 400 may display the interface shown in FIG. 4B.

Referring now to FIG. 4B, the interaction example 400 may include the read-only text input box 421 for showing the target user name and a message box 422 for sharing a collection by the user. The message box 422 for sharing a collection by the user may include collections 429, 433, 437 and 441 etc. And the collections 429, 433, 437 and 441 etc. may include operative controls 431, 435, 439 and 443 etc. In some embodiments, the user may click any of the operative controls 431, 435, 439 and 443 etc. to send the corresponding collection to the target user. Once detecting the clicking operation of the user on any of the operative controls 431, 435, 439 and 443 etc., the interaction example 400 may display the interface shown in FIG. 4C.

As shown in FIG. 4C, the interaction example 400 may include the read-only text input box 421 for showing the target user name, the read-only text input box 445 for displaying the message from the target user, the interactive control 447 for sharing a collection, the read-only text input box 453 for displaying the message for the target user from the user, the operative control 455 for sharing collection and the editable text input box 457 for the user to input a message for the target user. In some embodiments, the interactive control 447 for sharing a collection may include the product controls for sharing products 449 and 451 etc. In some embodiments, the target user may click the interactive control 447 for sharing a collection to access all the products in the collection. In some embodiments, the target user may click any of the product controls for sharing products 449 and 451 etc. to access any of the products. Once detecting the clicking operation of the target user on the interactive control 447, the interaction example 400 may display the interface shown in FIG. 4D. And once detecting the clicking operation of the target user on any of the product controls for sharing products 449 and 451 etc., the interaction example 400 may display the interface shown in FIG. 4E.

Referring now to FIG. 4D and 4E, in FIG. 4D, the interaction example 400 may include the collection interface 459 for shopping in the client 420 of the target user. In some embodiments, the collection interface 459 may include the read-only text input boxes 461 and 467 etc. for introducing products. In some embodiments, the read-only text input boxes 461 and 467 etc. may include the shopping cart controls 463 and 469 etc. for storing the products to be buy. In some embodiments, the read-only text input boxes 461 and 467 etc. may include the buying controls 465 and 471 etc. for the target user to buy the products. In FIG. 4E, the interaction example 400 may include the collection interface 473. In some embodiments, the collection interface 473 may include the shopping cart control 475 for storing the products to be buy. In some embodiments, the collection interface 473 may include the buying control 477 for the target user to buy the products. In some embodiments, the target user can click the shopping cart controls 463 and 469 etc. in FIG. 4D or the shopping cart control 475 in FIG. 4E to storing the products to be buy. In some embodiments, the target user can click the buying controls 465 and 471 etc. in FIG. 4D or the buying control 475 etc. in FIG. 4E to buy the products.

In this way, the interaction example 400 enables users to share collections among the same application and the same platform, greatly facilitating collection sharing among users of the same application or the same platform, and enables the sharing of product information between the application and the same platform, thus greatly improving the user experience of the users among the same application and the same platform.

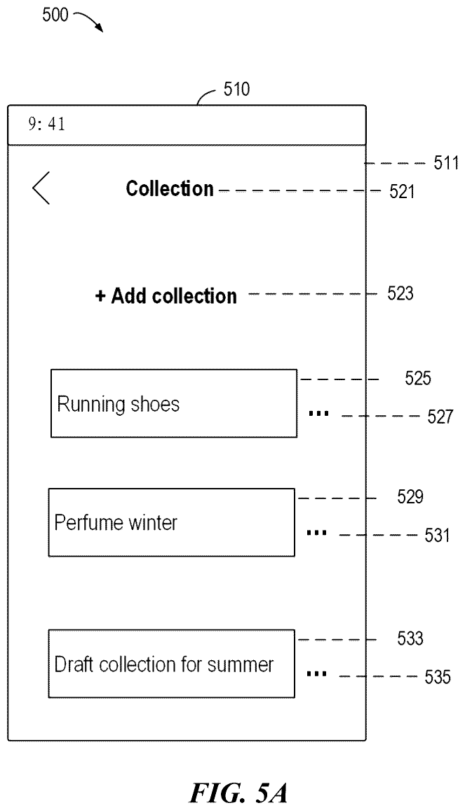

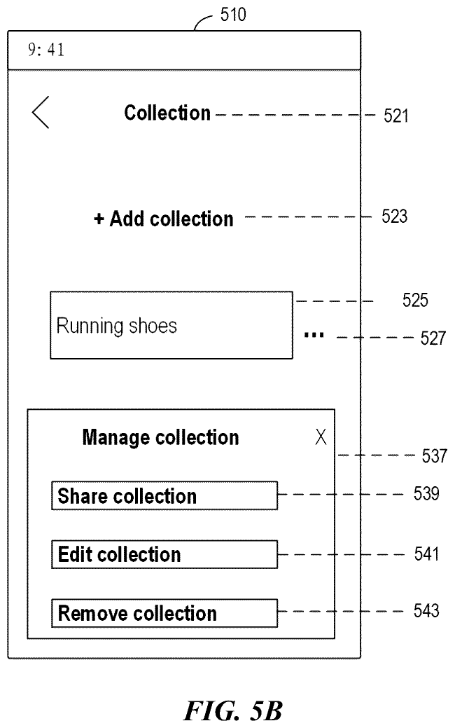

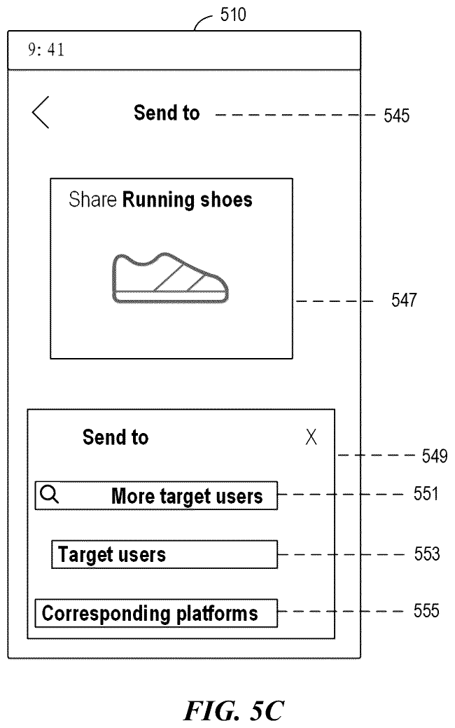

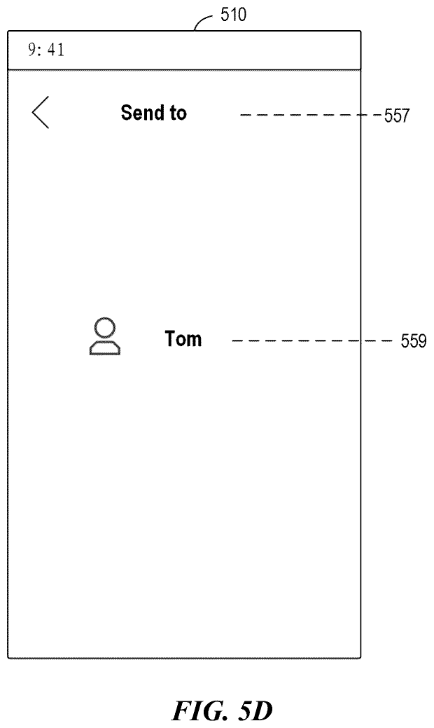

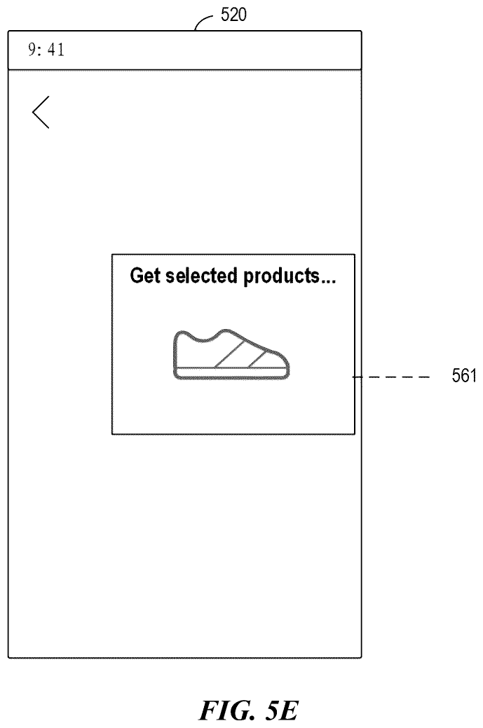

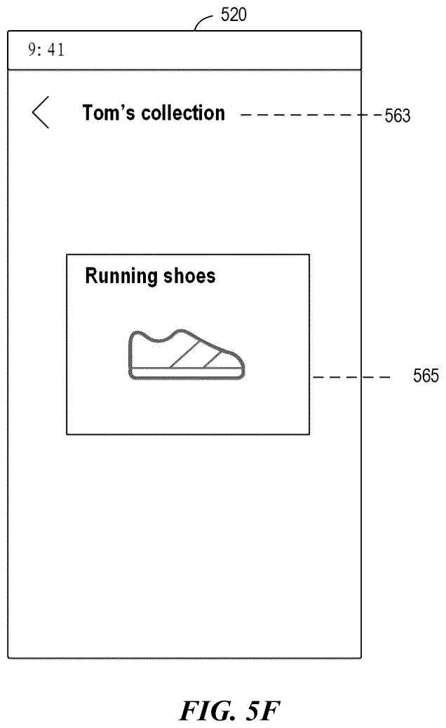

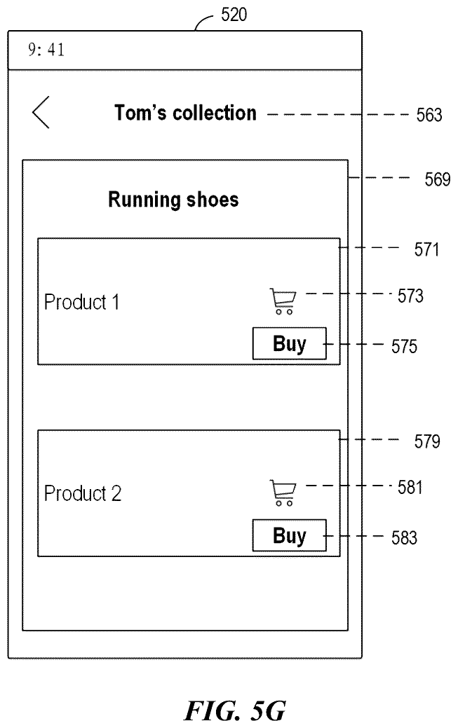

To help those skilled in the art further understand the present disclosure, FIGS. 5A to 5G illustrate schematic diagrams of an interaction example 500 for sharing a collection across different platforms through a collection interaction interface according to some embodiments of the present disclosure. FIG. 5A illustrates an example of an initial state to share a collection within different platforms according to some embodiments of the present disclosure. FIG. 5B illustrates an example of a message box for managing a collection according to some embodiments of the present disclosure. FIG. 5C illustrates an example of a message box for sending a collection to a target user according to some embodiments of the present disclosure. FIG. 5D illustrates an example of selecting a target user to send a collection according to some embodiments of the present disclosure. FIG. 5E illustrates an example of receiving the link of the shared collection by a target user linked to a different platform according to some embodiments of the present disclosure. FIG. 5F illustrates an example of reviewing the received link of the shared collection by the target user according to some embodiments of the present disclosure. FIG. 5G illustrates an example of displaying the received collection according to some embodiments of the present disclosure. It is worth noting that the collection interaction interface illustrated in the interaction example 300 for generating a collection through a collection interaction interface is merely exemplary. Those skilled in the art may employ any suitable interaction interface based on the basic concepts of the present disclosure to implement one or more embodiments of the present disclosure. Any suitable interaction interface based on the basic concepts of the present disclosure shall fall within the scope of protection of the present disclosure.

As shown in FIG. 5A, the interaction example 500 includes the collection interface 511 displayed in the client 510. The collection interface 511 includes the read-only text input box 521 for a collection, the operative control 523 for create a new collection, the collections 525, 529 and 533 etc., and the interactive controls 527, 531 and 535 etc. for managing collection. Once detecting the clicking operation of the user on any of interactive controls 527, 531 and 535 etc., the interaction example 500 may display the interface shown in FIG. 5B.

Referring now to FIG. 5B, the message box 537 for manage a collection is displayed. In some embodiments, the message box 537 may include the share collection control 539 for sharing a collection accordingly. In some embodiments, the message box 537 may include the edit collection control 541 for editing a collection. In some embodiments, the message box 537 may include the remove collection control 543 for removing or deleting a collection. Once detecting the clicking operation of the user on the interactive control 527 in FIG. 5A and detecting the clicking operation of the user on the share collection control 539 in FIG. 5B, the interaction example 500 may display the interface shown in FIG. 5C.

As shown in FIG. 5C, the interaction example 500 may include the read-only text input box 545 for description of sending the selected collection, the selected collection 547, and the send message box 549 for sending the selected collection. In some embodiments, the send message box 549 may include the search control 551 for searching a target user to share the selected target users, the target user list 553 and the corresponding platform list 555. In some embodiments, the user can search the target user through the search control 551, or select the target user from the target user list 553 and the corresponding platform list 555. Once detecting the selecting operation from the target user list 553 and/or the corresponding platform list 555, the interaction example 500 may display the interface shown in FIG. 5D. In FIG. 5D, the interaction example 500 displays the read-only text input box 557 for sending the selected collection, and the target user control 559 for identifying the target user “Tom”. In some embodiments, the user can click the target user control 559 to send the selected collection to the target user “Tom”.

As shown in FIG. 5E, the target user client 520 has received the link of the shared collection 561. Once detecting the clicking operation of the target user on the link of the shared collection 561 in FIG. 5E, the application linked by the target user will display an interface in the target user client 520 as FIG. 5F. And FIG. 5F shows the target user “Tom” has received the shared collection 565 in his collections 563. The target user “Tom” can read the brief introduction of the shared collection 565, even the target user “Tom” has not yet installed the same application and linked to the same platform linked by the user. If the target user “Tom” clicks the shared collection 565, the target user “Tom” may be reminded to download the same application used by the user to review the detail information of the shared collection 565. On the other hand, if the target user “Tom” has installed the same application used by the user, once detecting the clicking operation of the target user “Tom” on the shared collection 565 in FIG. 5F, the interaction example 500 may display the detail information of the shared collection 565 in FIG. 5G.

Referring now to FIG. 5G, FIG. 5G shows the target user “Tom” 563 and the shared collection 569. In some embodiments, the shared collection 569 may include the product controls 571 and 579 etc. In some embodiments, the product controls 571 and 579 etc. may include the shopping cart controls 573 and 581 etc. for storing the products to be buy and the buying controls 575 and 583 etc. for the target user to buy the products. In this way, the interaction example 500 enables users to share collections between different applications and different platforms, greatly facilitating collection sharing among users of different applications or different platforms, and enables the sharing of product information between different applications and different platforms, thus greatly improving the user experience.

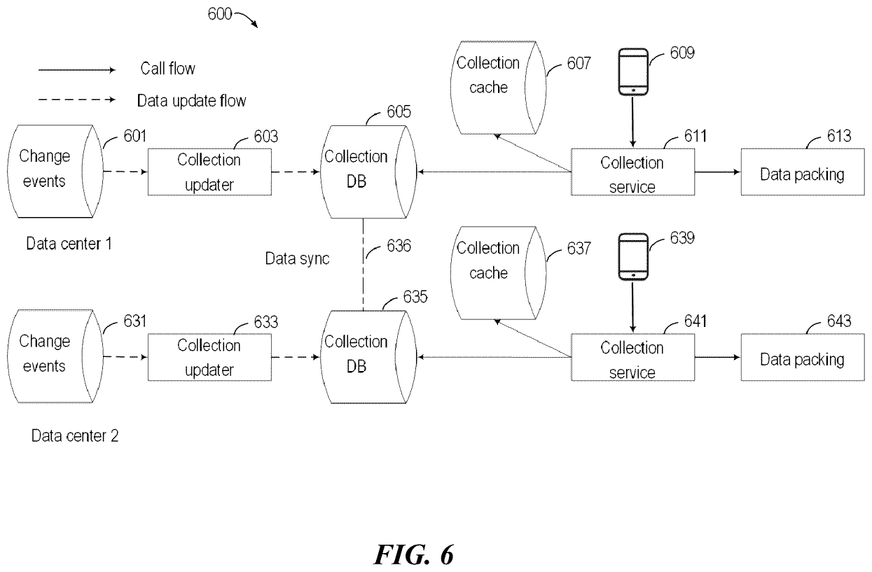

In order to further help those skilled in the art understand the backend collaboration of one or more embodiments of the present disclosure, FIG. 6 shows a schematic diagram of the collaborative work of different data centers used in the present disclosure for creating or sharing collections according to some embodiments of the present disclosure. This disclosure is supported by an underlying system that enables users to manage collections of products. This underlying system 600 provides users with the ability to create new collections, modify existing ones, and remove collections as needed. Additionally, creators can add eligible products to their collections and view the contents of these collections along with essential product information such as product name, price, commission, and associated labels. In FIG. 6, the data center 1 and data center 2 work independently, and the collection database 605 of the data center 1 and the collection database 635 of the data center 2 may synchronize data at 636. In some embodiments, in the data center 1, the change events 601 may be updated in the collection database through the collection updater 603. In some embodiments, the client 609 interacts with the collection service 611 and the interaction data may be received or stored in the collection cache 607 or the collection database 605. In some embodiments, the collection service 611 may provide the product data packing service 613. Similarly, in the data center 2, the change events 631 may be updated in the collection database through the collection updater 633. In some embodiments, the client 639 interacts with the collection service 641, and the interaction data may be received or stored in the collection cache 637 or the collection database 635. In some embodiments, the collection service 641 may also provide the product data packing service 643.

In some embodiments, the collection databases 605 and 635 store only essential identifiers and status attributes for products within collections. This approach optimizes storage and update operations. In some embodiments, in order to ensure high availability and fault tolerance, the collection data is synchronized across multiple data centers 1 and 2 etc. This multi-data center replication guarantees that in the event of a failure in one data center, other data centers can seamlessly continue to serve requests without data loss or service interruption.

In some embodiments, in order to maintain synchronization between the product status and the collection database, the system employs the collection updater 603 and 633 (collection product updater component). The collection updater 603 and 633 may subscribe to message queues that publish events related to product changes and associated plan status updates. Upon receiving such events, collection updater 603 and 633 may modify the product status entries in the collection databases 605 and 635 accordingly, ensuring that the collection reflects the latest product availability and plan conditions. In some embodiments, basic product details such as title, image, and price may be not stored statically in the databases 605 and 635 but may be fetched in real-time during user requests. This database design of the present disclosure guarantees that users always see the most up-to-date product information without requiring frequent database updates.

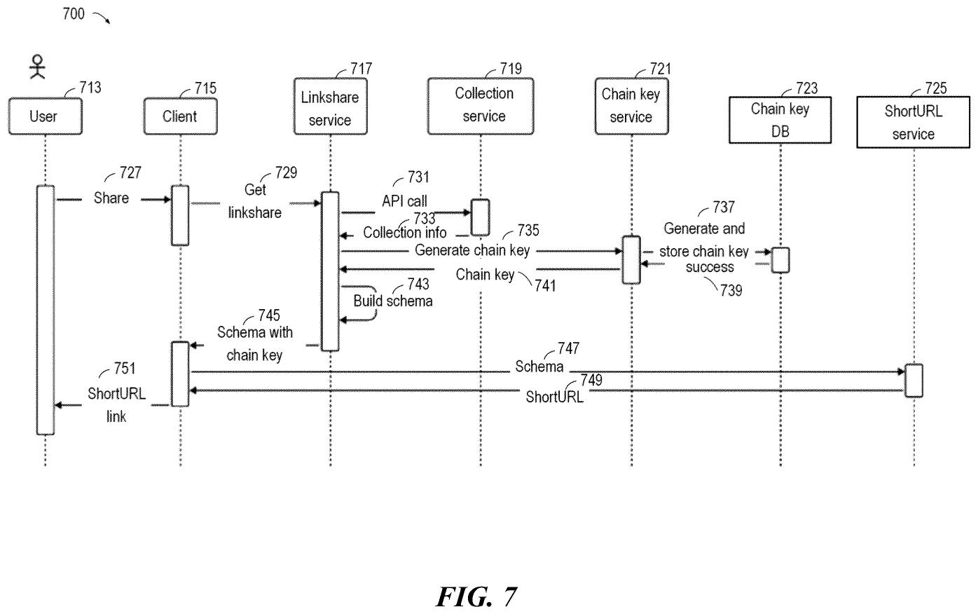

In order to further help those skilled in the art understand the whole process of sharing product collections between users, FIG. 7 shows a schematic diagram of the sharing workflow process according to some embodiments of the present disclosure. The present disclosure provides a secure and efficient mechanism for sharing product collections between users through the generation of a unique chain key and a short URL. This enables seamless sharing, tracking, and access control for collections across platforms. In FIG. 7, the sharing system 700 may include the user interface 713, the user client 715, the linkshare service module 717, the collection service module 721, the chain key database 723 and the short URL service module 725. In some embodiments, the user interface 713 may initiates the sharing process. And the linkshare service module 717 may orchestrate the collection sharing workflow, and the collection service module 721 may provide collection data. And the chain key service module 723 may generate and manage unique chain keys. In some embodiments, the chain key database 723 may stores generated chain keys for validation and tracking, and the short URL service module 725 may converts sharing schemas into short, shareable URLs.

In some embodiments, the sharing process begins when a user initiates share action via the user interface 713 at 727 by using the user client 715. The linkshare service module 717 may receive the user's request to get linkshare at 729, and calls the collection service module 719 at 731 to retrieve the relevant collection information at 733. In some embodiments, the linkshare service module 717 may request the chain key service module 721 at 735 to generate and return a unique chain key for this sharing session at 741. In some embodiments, the chain key service module 721 may create the key and stores it in the chain key database 723 at 737 and 739, then returns the chain key to the linkshare service module 717 at 741. In some embodiments, the linkshare service module 717 may build an in-app schema that includes the collection data and the generated chain key at 743, and the constructed in-app schema may be sent to the user client 715 with the generated chain key at 745.

In some embodiments, the constructed in-app schema may be sent to the short URL service module 725 by the user client 715 at 747, and the short URL service module 725 may generate a short URL representing the schema and return the short URL to the user client 715 at 749, which can share the short URL with others. And the user client 715 may display the short URL link in the user interface 713 at 751. The user can choose an internal or external platform to share on the panel. In some embodiments, when the user clicks the shared link, the application is launched and the in-app schema is used to open the specific collection page. In some embodiments, if the recipient purchases a product from the collection page accessed through the link, the chain key is utilized to track the user's sales activity.

In this way, the sharing system 700 effectively addresses the challenges of sharing collections on external platforms by providing each shared link with a chain key, enabling precise tracking and management of shared collections across different external channels. And the sharing system 700 further effectively addresses the challenges of sharing collections on external platforms by facilitating seamless and user-friendly sharing through the generation of short URLs, making it easy to distribute collection links on various social media, messaging applications, or even third-party sites.

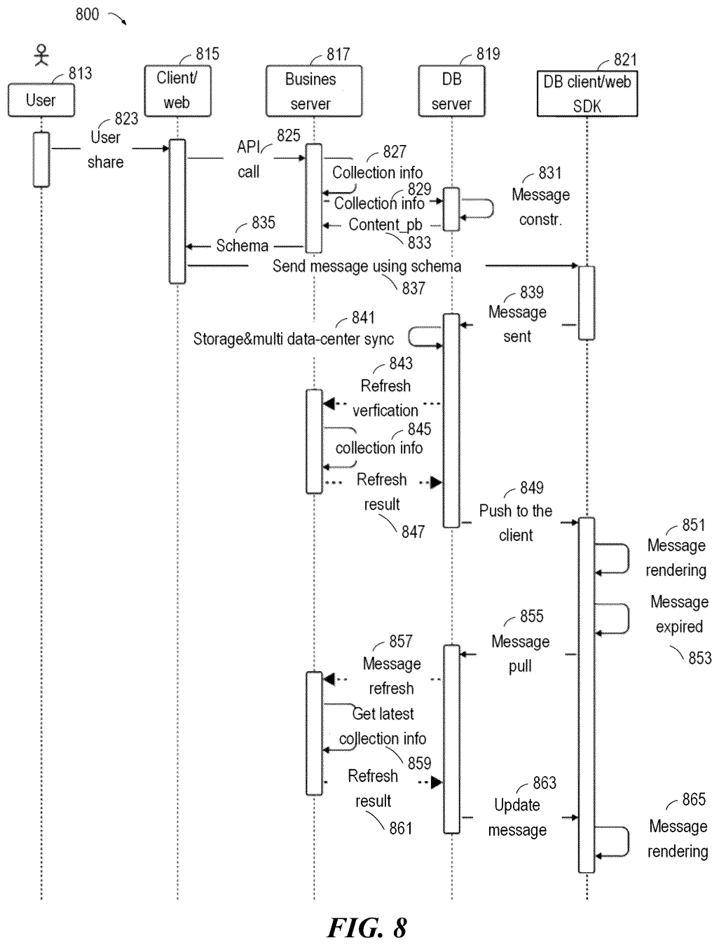

In order to further help those skilled in the art understand the whole process of sharing product collections between users, FIG. 8 shows a schematic diagram of the sharing workflow process for sharing product collection through in-application direct message channels according to some embodiments of the present disclosure. The present disclosure provides the system 800 for sharing product collection through in-application direct message channels. The system 800 enables users to initiate sharing actions from a business client or web interface, with the content being systematically packaged, transmitted, and delivered via the data management infrastructure for seamless end-user communication and interaction. In some embodiments, the system 800 may include the user interface 813, the business client/web 815, the business server 817, the data management server 819 and the data management client/web Software Development Kit (SDK) 821. In some embodiments, the user interface 813 may be used to initiates the sharing action by the user, and the business client/web 815 may be the user-facing application that processes the share request. In some embodiments, the business server 817 may provide the backend service responsible for retrieving the latest collection info, constructing the share schema, and orchestrating the data management workflow etc. In some embodiments, the data management server 819 may manage message construction, delivery, storage, multi-data-center synchronization, and message refresh logic, and the data management client/web SDK 821 may receive, render, and refresh the shared message on the recipient's device.

In some embodiments, the user initiates share through the business client/web interface at 823. And the business client/web 815 sends an API call to the business server 817 at 825 to process the share request. The business server 817 retrieves the latest collection information at 827 to build message content. In some embodiments, the business server 817 requests the data management server 819 at 829 to build message content at 831 and send the message content back at 833. Based on the message content, the business server 817 builds an in-application schema that will be sent to the business client/web 815 at 835.

In some embodiments, the business client/web 815 sends messages using schema to the data management Client/web SDK 821 at 837, and the data management Client/web SDK 821 sends messages to the data management server 819 at 839, which constructs the data management message, stores, synchronizes and verifies it at 841, 843, 845 and 847 etc. In some embodiments, the data management server 819 pushes the message to the data management client/web SDK 821 at 849, where it is rendered for the recipient at 851.

In some embodiments, if the message content becomes outdated or expires by change in collection at 853, the data management client/web SDK 821 can request a message refresh at 855. The data management server 819, upon receiving a refresh request, retrieves the latest collection info from the business server 817 at 857, 859 and 861 and returns the updated message at 863 to the data management client/web SDK 821. And the data management client/web SDK 821 re-renders updated messages at 865.

In this way, the system 800 directly addresses the core challenges associated with sharing product collections through direct messaging channels. One or more embodiments of the present disclosure have ensured data freshness by enabling real-time message refresh, recipients always see the most current version of a shared collection, even if items or details in the collection change after the initial sharing. And One or more embodiments of the present disclosure have improved user trust and engagement. In this way, users can confidently share collections knowing that recipients will interact with up-to-date information, which builds trust and encourages more frequent sharing and engagement. On the other hand, the architecture of the system 800 supports various types of collections and business scenarios, allowing businesses to extend this sharing capability to different products, campaigns, or content types by developing custom in-application schemas that include the specific information relevant to each scenario.

In summary, after a collection is created, the collection of one or more embodiments of the present disclosure can be conveniently accessed and called in various application scenarios. When shared outside the platform, one or more embodiments of the present disclosure can display a preview of the collection outside the terminal, including the collection description and product collection, and then jump to the relevant application after the user clicks. When shared within the platform, one or more embodiments of the present disclosure can access the collection in the shortcut area with one click and send it to the target user with one click, thereby greatly improving the user experience and achieving good technical results.

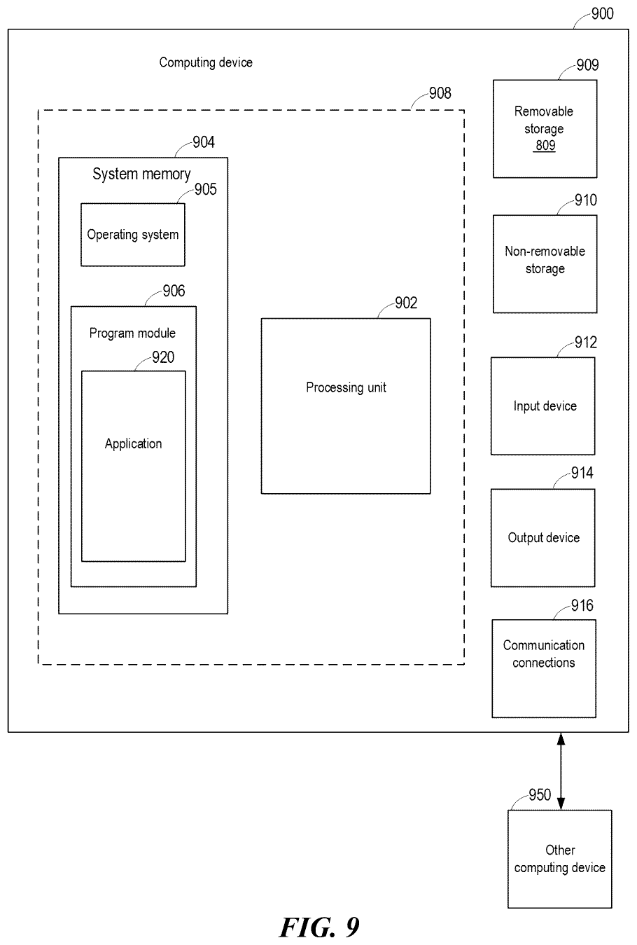

FIG. 9 is a block diagram illustrating physical components (e.g., hardware) of an electronic device 900 with which aspects of the disclosure may be practiced. For example, the electronic device 900 may implements the processes as depicted in FIGS. 2, 4 and 6. In a basic configuration, the processing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories.

The system memory 904 may include an operating system 905 and one or more program modules 906 suitable for performing the various aspects disclosed herein such. The operating system 905, for example, may be suitable for controlling the operation of the processing device 900. Furthermore, aspects of the disclosure may be practiced in conjunction with other operating systems, or any other application program and is not limited to any particular application or system. This basic configuration is illustrated in FIG. 9 by those components within a dashed line 908. The processing device 900 may have additional features or functionality. For example, the processing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, several program modules and data files may be stored in the system memory 904. While executing on the at least one processing unit 902, an application 920 or program modules 906 may perform processes including, but not limited to, one or more aspects, as described herein. The application 920 may include an application interface 921 which may be the same as or similar to the application interface 921 as previously described in more detail. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The processing device 500 may include one or more communication connections allowing communications with other computing or processing devices 950. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 900. Any such computer storage media may be part of the processing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method, comprising:
displaying an interactive control for creating a collection;
in response to detecting a user operation on the interactive control for creating a collection, creating the collection for the user;
displaying at least one object with an interactive control for adding the object to the collection; and
in response to detecting a user operation on the interactive control for adding the object to the collection, adding a link of the object into the collection, wherein the collection comprises a plurality of links of a plurality of objects.

2. The method according to claim 1, further comprising:
displaying an input field for naming the collection;
in response to detecting a user input in the input field for naming the collection, receiving a user input for naming the collection; and
generating, based on the user input for naming the collection, a name for the collection.

3. The method according to claim 1, further comprising:
displaying an input field for describing the collection;
in response to detecting a user input in the input field for describing the collection, receiving the user input for describing the collection; and
generating, based on the user input for describing the collection, a description for the collection.

4. The method according to claim 1, further comprising:
receiving a user search request for the object;
searching data of the object; and
displaying the data of the object.

5. The method according to claim 1, further comprising:
displaying an interactive control for sharing the collection;
in response to detecting a user operation on the interactive control for sharing the collection, sending the collection to a target user device specified by the user.

6. The method according to claim 5, wherein the target user device is linked to a different platform from a platform linked by the user device.

7. The method according to claim 5, wherein in response to detecting the user operation on the interactive control for sharing the collection, a chain key is generated for a session for sharing the collection, and a schema is generated for sharing the collection based on data of the collection and the chain key.

8. The method according to claim 7, wherein a short Uniform Resource Locator (URL) representing the schema is generated based on the schema for sharing the collection.

9. The method according to claim 8, wherein sending the collection to the target user device specified by the user device comprises:
sending the short URL of the collection to a target user device specified by the user device.

10. The method according to claim 9, wherein in response to receiving a request to access the collection from the target user device and the target user device being linked to a platform linked by the user device, a specific page of the collection is sent to the target user device.

11. The method according to claim 10, wherein the request to access the collection from the target user device is sent via clicking the shared short URL by the target user.

12. The method according to claim 11, wherein the specific page of the collection is opened by the target user based on the schema.

13. The method according to claim 10, wherein a sales activity of the target user is tracked based on the chain key.

14. The method according to claim 1, further comprising:
displaying a plurality of platforms for the user to select to share the collection.

15. The method according to claim 14, further comprising:
in response to detecting a user selection of a platform of the plurality of platforms; and
sending the collection to the selected platform linked by a target user device specified by the user.

16. The method according to claim 15, wherein the collection is shared by the target user to a second target user among the plurality of platforms.

17. The method according to claim 1, further comprising:
displaying an interactive control for renewing the collection;
in response to detecting a user operation on the interactive control for renewing the collection, updating data of the collection; and
displaying the updated collection for the user.

18. The method according to claim 17, wherein the updated collection is re-rendered based on the updated data of the collection.

19. An electronic device, comprising:
a memory and a processor;
wherein the memory is configured to store one or more computer instructions which, when executed by the processor, cause the processor to:
display an interactive control for creating a collection;
in response to detecting a user operation on the interactive control for creating a collection, create the collection for the user;
display at least one object with an interactive control for adding the object to the collection; and
in response to detecting a user operation on the interactive control for adding the object to the collection, add a link of the object into the collection, wherein the collection comprises a plurality of links of a plurality of objects.

20. A non-transitory computer-readable medium comprising instructions stored thereon which, when executed by a processor, cause the processor to:
display an interactive control for creating a collection;
in response to detecting a user operation on the interactive control for creating a collection, create the collection for the user;
display at least one object with an interactive control for adding the object to the collection; and
in response to detecting a user operation on the interactive control for adding the object to the collection, add a link of the object into the collection, wherein the collection comprises a plurality of links of a plurality of objects.
